(19) United States
(12) Patent Application Publication
(10) Pub. No.: US 2020/0250847 A1
(43) Pub. Date: Aug. 6, 2020

(54) SURFACE RECONSTRUCTION OF AN ILLUMINATED OBJECT BY MEANS OF PHOTOMETRIC STEREO ANALYSIS

(71) Applicant: OSRAM GmbH, Munich (DE)

(72) Inventors: Bernhard Siessegger, Unterschleissheim (DE); Fabio Galasso, Garching (DE); Nicolau Leal Werneck, Venlo (NL); Herbert Kaestle, Traunstein (DE)

(21) Appl. No.: 16/637,281

(22) PCT Filed: Jul. 31, 2018
(86) PCT No.: PCT/EP2018/070780

§ 371 Date: Feb. 7, 2020

(30) Foreign Application Priority Data
Aug. 8, 2017 (DE) 10 2017 213 761.4

(51) Int. Cl. G06T 7/586; G01B 11/24; G01B 11/25

(52) U.S. Cl. CPC G06T 7/586; G01B 11/2433; G06T 2207/10152; G06T 2207/20056; G01B 11/2545

(57) ABSTRACT

A method for surface reconstruction may include illuminating at least one object simultaneously by light emitted by a plurality of luminaires spaced apart from another. The method may further include recording a photographic sequence comprising a plurality of individual images of the object(s). The method may further include reconstructing at least one visible object surface of the object by photometric stereo analysis.

### CROSS-REFERENCE TO RELATED APPLICATIONS

The present application is a national stage entry according to 35 U.S.C. § 371 of PCT application No.: PCT/EP2018/070780 filed on Jul. 31, 2018; which claims priority to German Patent Application Serial No.: 10 2017 213 761.4, which was filed on Aug. 8, 2017; which is incorporated herein by reference in its entirety and for all purposes.

### TECHNICAL FIELD

A method pertaining to surface reconstruction is disclosed, wherein an object is illuminated by a plurality of luminaires spaced apart from one another, a plurality of individual images of the object are recorded, and a visible object surface of the object is reconstructed by means of photometric stereo analysis. An apparatus may carry out the method. The method is applicable for space monitoring of interiors and/or exteriors and/or for object recognition, such as in association with general lighting.

### BACKGROUND

Image-based photometric stereo analysis is a method for reconstructing the three-dimensional surface or surface structure of a scene or an object (referred to hereinafter just as object) by a sequence of individual images of the object being recorded under illumination conditions that vary in a controlled manner by means of a single digital camera, e.g. an RGB camera. In this case, the object is illuminated successively by different luminaires. The luminaires having a known relative intensity are situated at known positions and illuminate the object from different directions.

The individual images of an image sequence are assigned to the respective luminaires and used as input images of the photometric stereo analysis. Since the surfaces that are not visible to the camera cannot be reconstructed, this method is also referred to as “2½ D” reconstruction.

In this case, assuming that the reflection properties of the object are Lambertian, the brightness of a surface region or surface point of the object as detected by the camera is dependent only on the illumination angle or angle of incidence of the light and not on the viewing direction of the camera. This means that surface regions or surface points maintain their appearance independently of the viewing direction of the camera.

Taking account of the fact that an observed or measured brightness of a surface region corresponds to a value of a corresponding pixel (can also be referred to as pixel brightness or luminance value) of the camera, the surface vectors at corresponding surface regions or surface points and also the diffuse albedo there can be determined if a plurality of individual images of the object are recorded under different illumination conditions.

By way of example, the following steps can be carried out for traditional photometric 2½ D reconstruction:

1. The intensity or brightness and also an orientation of the luminaires are determined or defined. A position of the luminaires advantageously covers a high angle variation, specifically without shadow casting on the object surface and without self-shading.

A mutual calibration of the luminaires with regard to their intensity and illumination direction is then carried out. This can be achieved for example by the light intensity being measured by means of a luxmeter or being determined by the evaluation of an image of a calibrated object having a known geometry and a known albedo value (e.g. a sapphire sphere). The result of the calibration can be expressed in the form of a set of illumination vectors Li, wherein the magnitude of the illumination vector Li corresponds to a relative intensity of the associated luminaire i and the direction of the illumination vector Li determines the angle of incidence.

2. An object is recorded under a predefined illumination from a respective one of the luminaires by means of a conventional 2D camera. The viewing direction of the camera is arbitrary in principle, but advantageously so as to achieve a good perspective on an object surface with as little shading as possible.

3. The pixel values (pixel measurement values) PMw(x,y) of the pixels BP(x,y) of the recorded individual images (also referred to as “Capture Pixel Values”) depend on the observed luminance of each of the surface regions or surface points of the object surfaces.

For each of the pixels BP(x,y) corresponding to a surface region or surface point at the location (x,y), this can also be expressed such that

PMw(x,y); i=ρd(x,y)*(Li·n(x,y))

wherein PMw(x,y); i represents the pixel value of said pixel BP(x,y) under illumination from only the luminaire i, ρd(x,y) represents the albedo of the associated surface region or of the associated location (x,y), Li represents the (normalized) illumination vector Li and n(x,y) represents the normal vector of the associated surface region/surface point or of the location (x,y). Each surface element or each location (x,y) thus contributes with its albedo ρd(x,y) and with its normal n(x,y) precisely to the pixel measurement value PMw(x,y), specifically depending on the illumination intensity Li.

(Li·n) is thus a vector product including the magnitude of the illumination vector Li and the cosine of the angle of incidence Θi, namely in accordance with (Li·n)=|Li|·cos(Θi).

4. For three luminaires i=1, 2, 3 for a pixel and thus also an associated surface region, the following equation system thus results:

PMw(x,y); 1=ρd*(L1·n(x,y))

PMw(x,y); 2=ρd*(L2·n(x,y))

PMw(x,y); 3=ρd*(L3·n(x,y))

From this equation system, it is possible to determine the albedo ρd(x,y) and the normal vector n(x,y) taking account of the normalization condition |n|=1.

This can be carried out separately for each of the pixels BP(x,y).

An object having an unknown (surface) albedo ρd can thus be reconstructed with the aid of three different illumination scenarios. For the case where the albedo of an object surface is already known (for example the object has been pretreated and/or painted with defined color), the traditional photometric stereo analysis can also be carried out with only two luminaires.

5. The surface reconstruction can be carried out with the normal vectors n of the pixels or surface regions in order to obtain complete information about the three-dimensional structure or shape of the object surface, e.g. by way of gradient considerations and subsequent integration.

By rescaling the ascertained normal vectors

n(x,y)=(nₓ(x,y),n_{y}(x,y),n_{y}(x,y))

to give

Nₓ(x,y)=−nₓ(x,y)/n_{z}(x,y)

and

N_{y}(x,y)=−n_{y}(x,y)/n_{z}(x,y),

it is possible to reconstruct the surface by integration

z(x,y)=∫ₓ_{₀}^{x}Nₓ(x,y₀)dx+∫_{y}_{₀}^{y}N_{y}(x₀,y)dy+z₀

One disadvantage of the conventional photometric stereo analysis is that the illumination of the object together with the image recording requires a great deal of time, and so it is hardly suitable for real-time applications in the field of general lighting. Moreover, background illumination (not originating from the luminaires) has to be eliminated in the conventional photometric stereo analysis. Said background illumination has to be subtracted from the individual images each time.

### SUMMARY

The problem addressed by the present invention is that of at least partly overcoming the disadvantages of the prior art and providing in particular an improved possibility of surface reconstruction on the basis of the photometric stereo analysis.

The problem is solved by means of a method for surface reconstruction, wherein (i) at least one object is illuminated simultaneously by a plurality of luminaires spaced apart from one another, (ii) a photographic sequence including a plurality of individual images of the at least one object is recorded, and (iii) at least one visible object surface is reconstructed by means of photometric stereo analysis.

In this case, the light emitted by the luminaires is modulated with different modulation frequencies. Then, the light components of the respective luminaires that are reflected by the object are identified on the basis of their modulation and are assigned to respective partial images. Subsequently, the partial images are used as input images for the photometric stereo analysis.

One advantage of the method is that the light components can be extracted from the recorded photographic sequence at the same time or simultaneously on account of the modulation. The three or more (partial) images associated only with the respective luminaires need no longer be recorded sequentially or successively since all three or more luminaires are coded and can thus be operated in parallel and in particular remain permanently switched on. Moreover, the background illumination then no longer need be subtracted from the individual images in a complex manner, but rather—since it is not modulated—is simply not taken into account.

As a result, the reconstruction is advantageously able to be carried out in real time, specifically also in the field of general lighting, e.g. for space monitoring and object recognition, in particular for recognizing the presence of human beings and their activity. The reconstruction of the visible object surface can be carried out after the creation of the partial images by conventional methods. Object recognition, etc. can in turn be carried out by means of the reconstructed surfaces. The German term “Oberflächenrekonstruktion” is also often referred to as “Surface Reconstruction”.

The method for surface reconstruction can also be regarded or designated as a method for determining or calculating a or the shape and orientation of photographically recorded surfaces in space.

The light beams of the luminaires spaced apart from one another, which light beams are incident on a point of an object surface, have there in particular different angles of incidence (also referred to as illumination angles of incidence) and possibly different illuminances. The luminaires can have in particular different orientations or illumination directions.

One or else a plurality of object surfaces can be reconstructed by means of the method. For this purpose, it is advantageous, in particular, if (for example beforehand or during the method) the positions or coordinates of the plurality of objects or object surfaces in space are ascertained, for example by image data processing methods. This is advantageous because then the respective illumination angles of incidence of the three luminaires are known or can be ascertained in order subsequently to carry out the photometric stereo analysis.

A photographic sequence can be understood to mean in particular an image sequence or a video. The photographic sequence includes in particular a chronological sequence of individual images. The individual images can be recorded by means of a camera. The camera can be stationary. The individual images have in particular the same resolution, e.g. a matrix-type resolution with (m×n) pixels, e.g. of 640×480, 1024×640, 1920×1080, etc. pixels.

If the sampling rate f_s of the camera is high enough, the objects present in the individual images of a sequence can also still be assumed to be practically stationary if they do not move too rapidly. The number of individual images used for a sequence is not limited.

In one development, the individual images of a sequence are spaced apart from one another equidistantly in time.

The sequence can be arbitrary in principle. In this regard, the sequence can be a selection of a complete recording series of individual images. However, the predefined sequence corresponds in particular to a complete recording series of individual images or all individual images of a predefined time duration. The sequences can be “consecutive” sequences of a succession of 1 to m individual images EB: {EB1, EB2, . . . , EBn}, {EB2, EB3, . . . , EBn+1} etc. where n<m.

In one development which is advantageous for a particularly simple surface reconstruction, the luminaires are constructed identically. The luminaires may include one or more light sources (e.g. one or more LEDs).

The photometric stereo analysis is known in principle and serves for reconstructing the spatial object surface by means of evaluating two-dimensional (input) images of the object which were recorded in each case from three different known illumination directions. Respective illumination vectors L1, L2 and L3 not extending parallel to one another can be assigned to the different known illumination directions.

In order to utilize the photometric stereo analysis, hitherto three (or, with knowledge of the albedo, two) luminaires spaced apart from one another have been switched on successively and a respective image has been recorded with the luminaire switched on. The resulting images serve as input images for the photometric stereo analysis.

In one development, the emitted light of the independent spaced-apart luminaires is characteristically (individually) modulated. In particular, the different modulation frequencies do not constitute multiples of one another. By way of example, three luminaires can modulate their light with modulation frequencies of 210 Hz, 330 Hz and 440 Hz. This concept can be extended to more than three luminaires.

In order to prevent an occurrence of an intermodulation particularly effectively, the modulation frequencies are not, or not exactly, composed of multiples of integers. In this regard, it is possible to avoid intermodulation products which are identical to one of the modulation frequencies, e.g. if small nonlinearities occur in the camera or in the camera system. The modulation frequencies can be pairwise relatively prime, in particular. The modulation frequencies can be varied in principle.

The modulation can generally be understood as a coding of the light emitted by the luminaire, which coding makes it possible to identify or to extract the light components of said luminaire in a digital image, even though the object is irradiated simultaneously by a plurality of luminaires or the other luminaires simultaneously.

In one development, the modulation frequencies are in a range of between 50 Hz and 1000 Hz, in particular between 100 Hz and 1000 Hz, in particular between 100 Hz and 500 Hz. The lower limit of 50 Hz or even 100 Hz is advantageous in order that the luminaires do not flicker in a manner visible to the human eye. The upper limit is advantageous in order that, even at limited or low sampling rates f_s, an evaluation is still able to be carried out with small errors, which in turn enables a utilization of a cost-effective video technique or camera technique (e.g. with regard to a requirement made of the frame rate).

The fact that the light components of the respective luminaires that are reflected by the object are identified on the basis of their modulation and are assigned to respective (“extracted”) partial images makes it possible, in particular, for the extracted partial images to correspond (in particular to correspond exactly) to images which have only the light components of a specific luminaire. The partial images have in particular the same format as the photographically recorded individual images.

In one configuration, each pixel of the (temporal) sequence is subjected to a respective Fourier analysis, and Fourier components obtained from the Fourier analysis, as values of the corresponding pixels, are assigned to the respective partial images. This enables a particularly effective and rapid identification (in particular in “real time”) of the light components of the respective luminaires that are reflected by the object on the basis of their modulation. Moreover, the utilization of the Fourier components enables a simple possibility for not taking account of background illumination.

As is customary in Fourier analysis, the sampling rate defines the detectable frequency range, while the number of recorded individual images or the observation time determines the measurable frequency resolution. Both parameters can be adapted in order to obtain the fastest results for a specific modulation scheme.

A Fourier analysis can be understood to mean, in particular, carrying out a Fourier transformation, for example a fast Fourier transformation (FFT).

In other words, an associated time series of pixel values or pixel measurement values is determined for each pixel from a predefined group of individual images recorded in a manner offset in time. This (pixel-related) time series is subjected to a respective Fourier analysis. The Fourier transformation generates a Fourier spectrum having Fourier components as values in the frequency domain. The pixel values in the time domain can also be regarded as pixel values, measurement values, magnitudes, intensity values, luminance values or brightness values, e.g. within a value range of [0; 255] or [0; 1024], etc.

A floating point coding that is also possible has the advantage over an integer coding that the relative accuracy of the value is not dependent on its value itself. A lower pixel illumination value is transferred or represented with the same relative accuracy (e.g. 5%) as a high intensity value.

In one configuration, moreover, more than three or at least four luminaires spaced apart from one another with respective modulation frequencies are used. This affords the advantage that, as a result of an overdetermination, a spatial concealment or shading of a surface to be reconstructed can be reduced or even completely avoided.

In one configuration that is particularly advantageous for a more accurate reconstruction, the at least one object is illuminated simultaneously by more than three differently coded, in particular modulated, luminaires, accordingly more than three partial images associated with the respective luminaires are generated, then photometric stereo analyses are carried out for different luminaire combinations with in each case three partial images. Moreover, in particular at least two of the respectively resulting reconstructed object surfaces can then be combined or superimposed, e.g. placed one above another and/or averaged, to form a single final object surface. This configuration is particularly advantageous if luster images (also referred to as “specular albedo”) is present, e.g. if an object has at least partly a lustrous or specularly reflective surface. If a specular albedo is present, it occurs in the partial images only at specific locations on the object surface, wherein an occurrence and/or an intensity of these locations can be different for different partial images. That is to say that each of the partial images can contain lustrous locations of the object surface for which no usable information can be contributed. The superimposition of the reconstructed object surfaces makes it possible to find and eliminate the erroneous locations.

By way of example, if four luminaires a, b, c and d are used simultaneously, a respective photometric stereo analysis can be carried out for the luminaire combinations (abc), (abd), (acd) and (bcd). In this case, at least one of the respectively resulting reconstructed object surfaces may not deliver a meaningful reconstruction at specific locations. Superimposition of at least two of the four reconstructed object surfaces makes it possible to find and eliminate the erroneous (lustrous) locations.

The way in which the combination or superimposition of the reconstructed object surfaces is carried out is not limited, in principle. In this regard, in one development, all reconstructed object surfaces can be placed one above another and/or averaged. Particularly for suppressing luster effects, however, it is advantageous to combine only a subset of the reconstructed object surfaces, in particular such a subset which does not show the luster effect, or does not show it so greatly.

In one development, a majority decision is implemented for the selection of such a subset. For this purpose, those surface reconstruction values are used (optionally also used in an averaged or weighted manner) which correspond in a plurality (e.g. two or three) of reconstructed object surfaces at least within a predefined bandwidth. Alternatively or additionally, outlier tests can be carried out, e.g. outlier tests according to Grubbs or Nalimov.

It is particularly advantageous if the combination or superimposition of the previously reconstructed object surfaces is carried out individually for each surface point or surface region of the object surface. This can also be referred to as pointwise combination.

With a sufficiently high camera frame rate or sampling rate, the Nyquist-Shannon sampling theorem is satisfied, and after a Fourier analysis has been carried out, the number of Fourier components present is exactly the same as the number of modulation frequencies/modulated luminaires. This case can also be referred to as “standard Fourier analysis”. In this case, the frame rate is at least double the magnitude of the modulation frequencies of the luminaires. This is because with a sufficiently long video sequence (i.e. a sufficiently large number of individual images recorded), the frequency resolution is sufficient to be able still to distinguish between the different modulation frequencies. A resolution of 1 Hz to 10 Hz is often required, which corresponds to a video sequence length of one second. However, the method is not restricted to this frequency range.

In one configuration that is advantageous in particular for use with a standard Fourier analysis, the modulation frequencies are kept constant over time, the plurality of individual images are recorded with a frame rate that is higher than the modulation frequencies of the luminaires, and the Fourier analysis is carried out for a frequency range extending maximally to half the sampling rate (Nyquist frequency limit). In other words, the sampling rate f_s is at least twice the modulation frequency to be measured (which can also be referred to as light signal frequency or Nyquist frequency).

In this case, the Fourier analysis detects at each pixel directly the Fourier magnitudes associated with the modulation frequencies (i.e. the magnitude or level of the measured line), which reproduces the pixel measurement value (pixel value) on account of the irradiation by the corresponding luminaire.

This configuration has the advantage that the Fourier analysis (for each pixel) is implementable in a particularly simple manner and generates particularly accurate partial images.

A constant modulation frequency can be understood to mean, in particular, a modulation frequency which has a frequency fluctuation Δf_signal of less than 10 Hz, in particular of less than 5 Hz, in particular of less than 2 Hz, in particular of less than 1 Hz.

In one configuration, moreover, the light signal or modulation frequencies are kept constant over time, the plurality of individual images are recorded with a frame rate that is lower than at least one modulation frequency of the luminaires (in particular than all modulation frequencies of the luminaires), and the Fourier analysis is carried out for a frequency range extending maximally to half the sampling rate.

This configuration affords the advantage that a reconstruction of object surfaces can also be carried out using cameras or other image recording devices which have a comparatively low sampling rate, e.g. of approximately 30 frames per second (fps). Such cameras or the like are comparatively cost-effective.

The situation in which the plurality of individual images are recorded with a frame rate that is lower than at least one modulation frequency of the luminaires can also be referred to as “undersampling”. In the case of undersampling, the result of a Fourier analysis yields a plurality of Fourier components per modulation frequency. These Fourier components are at the associated alias frequencies f_alias, which arise in accordance with

f_alias=f_signal−n*f_s>0 where n=0, 1, 2, 3 etc.

wherein f_signal is the associated modulation frequency and f_s is the sampling rate. In the case where the Fourier analysis is applied to the sampled signal sequence, the parameters are advantageously chosen such that the Nyquist frequency of the Fourier analysis includes only the lowest expected alias frequency, while the higher-order alias frequencies are disregarded. Analogously, the sampling rate can be chosen such that the frequency resolution for detecting the lowest alias frequency expected is sufficient to be able to separate it from the adjacent lowest alias components of the other luminaires. Typically, for the parameterization of the Fourier analysis, the Nyquist frequency is set to f_s/2 (e.g. to 30 Hz/2=15 Hz) and the observation time is set to e.g. 1 sec, in order to achieve a frequency resolution of 1 Hz. For the case of undersampling, therefore, the Fourier analysis only detects the magnitudes (e.g. intensities) of the lowest alias frequencies of the actual modulation frequencies or light signal frequencies.

In one development, in each case the Fourier component having the smallest alias frequency f_alias per modulation frequency is used as “correct” Fourier component (the value of which is used further to create the partial images). The lowest alias frequency in terms of frequency engineering is also referred to as baseband signal.

The Fourier component of the smallest alias frequency contains the information of the associated signal amplitude (here as the information about the measurement value of the pixel for a specific modulation frequency), wherein only phase information is lost. All other Fourier components at a higher alias frequency are suppressed and not taken into account.

This can additionally or alternatively be achieved by means of a digital low-pass filter being applied to the sampled signal sequence, which filter can also be referred to as an anti-aliasing filter.

The smallest Fourier component per modulation frequency can then be used further to provide values for the pixels of the partial images, as already described above.

One possible case of the undersampling concept can be implemented as follows:

The modulation frequencies f_signal=fa, fb and fc of the luminaires i=a, b and c, respectively, read as follows:

fa=150 Hz+3 Hz=153 Hz

fb=(2·150 Hz)+6 Hz=306 Hz

fc=(3·150 Hz)+12 Hz=462 Hz

or

fa=150 Hz+3 Hz=153 Hz

fb=150 Hz+6 Hz=156 Hz

fc=150 Hz+12 Hz=162 Hz

The sampling rate f_s of e.g. 30 Hz is much smaller than the modulation frequencies fa, fb and fc, respectively. A recording time T of approximately one second makes it possible to read in a sampling sequence of 30 individual images.

On account of the undersampling, the Fourier analysis yields a set of Fourier components at alias frequencies fn_sub in the Fourier spectra of the respective pixels. The alias frequencies fn_alias are

fn_alias_n=f_signal−n·f_s, where n=1, 2, 3, . . .

The alias frequencies closest to the zero (baseband frequencies) are

fa_alias_5=3 Hz, (where n=5)

fb_alias_10=6 Hz, (where n=10)

fc_alias_15=12 Hz, (where n=15)

As a result of applying a digital low-pass or anti-aliasing filter having a cut-off frequency at 15 Hz, all other, higher-frequency alias frequencies are suppressed. In this case, the cut-off frequency of the—e.g. digital—filter has been set such that only the lowest alias components are seen. Only the baseband signals remain after the digital filtering.

If the digital filter is applied before the Fourier analysis is carried out, it is no longer necessary, or no longer necessary in a complex manner, to take care to ensure that the Nyquist frequency parameter of said Fourier analysis is not too high. In particular, it is then no longer necessary to carry out filtering with the Fourier analysis.

The baseband signals can be analyzed by means of customary Fourier analysis in order to find the position and size of the Fourier components.

It is thus possible either “actively” to apply a digital anti-aliasing filter and/or to parameterize the Fourier analysis in this way in order that the higher aliases lie above the Nyquist frequency chosen and are thus also no longer analyzed. The additional application of the digital anti-aliasing filter is advantageously more secure since in this case, unlike in the Fourier analysis, it is not necessary to reckon with mirror effects that can possibly take effect from frequencies above the Nyquist frequency.

In one configuration, moreover, the modulation frequencies are kept constant over time, the individual images are recorded with a frame rate that is lower than the modulation frequencies of the luminaires, the Fourier analysis is carried out for a frequency range extending at least to the respective modulation frequency, and measured Fourier components from a plurality of repeated measurements are averaged, wherein the sampling rate and the modulation frequency are not synchronized.

The lack of synchronization can also be referred to as random sampling or stochastic sampling.

Random sampling exploits the fact that if the light reflected from an object (i.e. measured “light signals”) is detected with a low sampling rate (undersampling), it still partly contains components or information of the higher-frequency modulation frequency (signal frequency). In this case, the remaining residual information in the sampled signal sequence depends on the random phase angle between the sampling frequency and the modulation frequency to be measured. If the sampling frequency is 30 Hz, for example, the sampled signal sequence is rasterized with a 30 Hz raster.

This rasterized signal sequence can be subjected to Fourier analysis, in particular by means of a standard Fourier analysis (without taking account of the undersampling) to a limit frequency above the sampling rate, in particular to half of the highest modulation frequency (e.g. 500 Hz) or to the highest modulation frequency (e.g. 1000 Hz).

The Fourier analysis yields rudimentary or attenuated values of the genuine Fourier components at the limit frequency. Since the low or slow sampling rate is not synchronized with the modulation frequency, the signal/noise ratio can be improved by repeated measurement (corresponding to the provision of different sequences). The case of random sampling thus exploits the fact that each image recording sequence can be subjected to Fourier analysis but, on account of the undersampling of individual images, contributes only a specific fraction to the “true” value or level of the Fourier components. By recording a sufficiently high number n of sequences, it is possible to obtain the true value by simple summation.

Under the assumption underlying random sampling that the recordings of the sequences are uncorrelated and are carried out at random points in time (which can be achieved e.g. by virtue of the sampling rate being independent of the modulation frequencies), the value of the Fourier components will increase linearly with the number n of recorded sequences. However, the noise increases only with the root of n. This results in a signal-to-noise ratio SNR where

SNR(n)=(f_s/f_nyquist)·n/sqrt(n)

wherein f_s is the sampling rate, e.g. 30 Hz, f_nyquist is twice the modulation frequency, e.g. 1000 Hz, and n is the number of recorded sequences. Since the useful signal rises with the factor n, while the noise rises only with the factor sqrt (n), the SNR rises with n/sqrt(n)=sqrt(n). By fixing the number n to a sufficiently high value, e.g. to n=100, for all the measurements, the measured Fourier component can be assumed to be a representative value and be used for generating the partial images, etc.

In one configuration, moreover, a respective modulation amplitude of the luminaires is kept constant. This facilitates carrying out the method and increases the accuracy thereof because a modulation depth corresponds to the intensity of the individual luminaires.

In one development that is advantageous for the same purpose, the modulation amplitude of the luminaires is of identical magnitude. This facilitates a calibration, in particular.

In one development, the amplitude depth (i.e. a ratio of the amplitude swing to a maximum amplitude Amax, that is to say [Amax-Amin]/Amax), is at least 5%, in particular at least 10%. This enables a particularly good detectability by a camera.

The problem is also solved by means of an apparatus configured for carrying out the method.

The apparatus may include, in particular, a plurality of luminaires spaced apart from one another, at least one camera, the field of view of which is directed into a spatial region capable of being illuminated by the luminaires, and an evaluation device.

The apparatus is configured, in particular, to modulate the light emitted by the luminaires with different modulation frequencies (for example by way of suitable drivers).

By means of the camera, it is possible to record a photographic sequence with a plurality of individual images.

By means of the evaluation device, the photographic sequence is able to be evaluated in order to reconstruct a visible object surface of an object situated in the field of view of the camera by means of photometric stereo analysis. The evaluation device can also be configured to carry out an object recognition on the basis of the reconstructed object surfaces.

In one development, the luminaires each include at least one light emitting diode.

In one development, the apparatus is a monitoring system or part of a monitoring system, for example for monitoring interiors and/or exteriors. The monitoring system can be a distributed system in which the evaluation device is arranged remotely from the luminaires and the camera.

### BRIEF DESCRIPTION OF THE DRAWINGS

In the embodiments and figures, components which are the same or of the same type, or which have the same effect, are respectively provided with the same references. The elements represented and their size ratios with respect to one another are not to be regarded as to scale. Rather, individual elements, in particular layer thicknesses, may be represented exaggeratedly large for better understanding.

FIG. 1 shows a monitoring system in accordance with a first exemplary embodiment;

FIG. 2 shows a sequence of individual images that were recorded by a camera of the monitoring system in accordance with the first exemplary embodiment;

FIG. 3 shows a time series of measurement values of a pixel of the sequence;

FIG. 4 shows a result of a standard Fourier analysis of the time series of measurement values;

FIG. 5 shows partial images obtained from the Fourier analysis;

FIG. 6 shows a monitoring system in accordance with a second exemplary embodiment;

FIG. 7 shows a time series of measurement values of a pixel of a sequence of individual images;

FIG. 8 shows a result of a standard Fourier analysis of the time series of measurement values that were recorded by the camera of the monitoring system in accordance with the second exemplary embodiment; and

FIG. 9 shows a determination of a surface point of a reconstructed surface from a set of a plurality of surface points.

### DETAILED DESCRIPTION

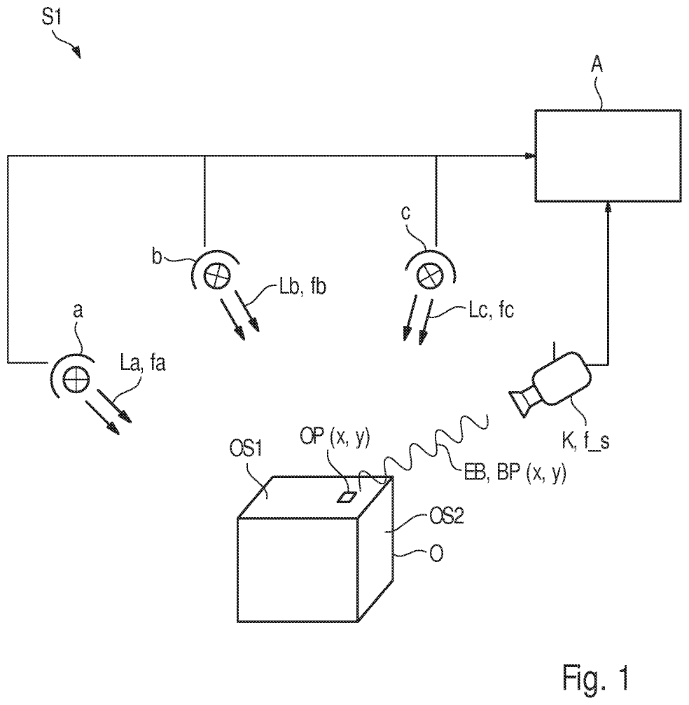

FIG. 1 shows a monitoring system S1 in accordance with a first exemplary embodiment. The monitoring system S1 includes three luminaires a, b and c, respectively, spaced apart from one another. The luminaires a to c are spaced apart from one another such that light emitted by them is incident on an object O at different angles of incidence. The monitoring system S1 furthermore includes a digital camera K, the field of view of which is directed into a spatial region capable of being illuminated by the luminaires a to c.

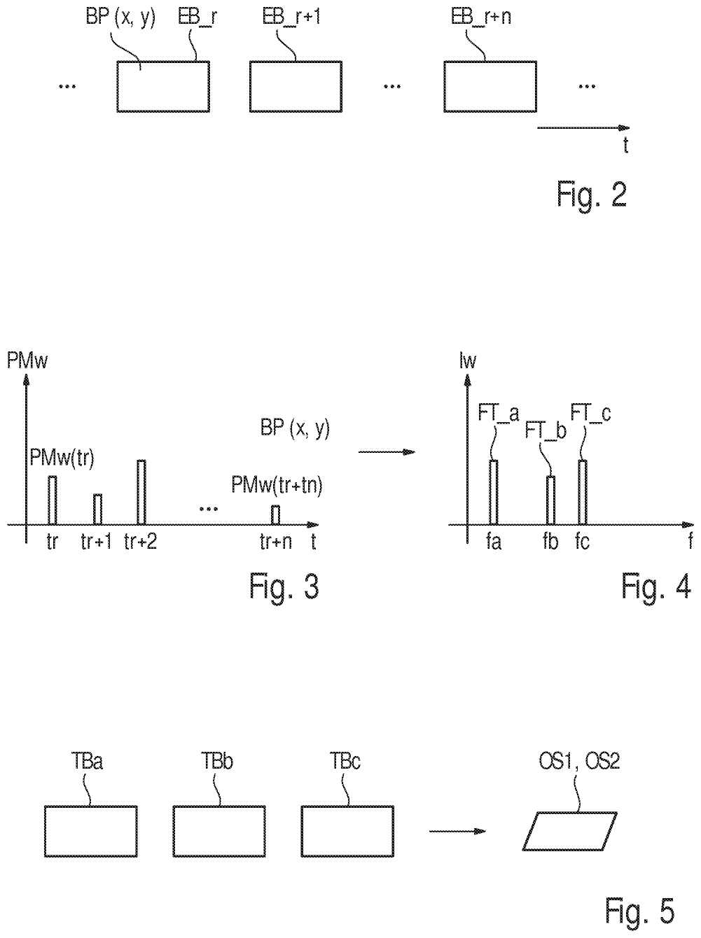

The camera K is able to record temporal sequences of individual images EB (see FIG. 2) with a specific sampling rate f_s. The object O is present or imaged in the individual images EB. A corresponding surface region or surface point OP(x,y) is assigned to each pixel BP(x,y) of an individual image EB.

The monitoring system S1 additionally includes an evaluation device A, by means of which the photographic sequence is able to be evaluated in order to reconstruct an object surface OS1, OS2 of the object O that is visible to the camera K by means of photometric stereo analysis. The evaluation device A can also be configured to carry out an object recognition and/or activity recognition on the basis of the reconstructed object surfaces OS1, OS2.

The monitoring system S1 is configured, in particular, to modulate the light La, Lb and Lc, respectively, emitted by the luminaires a to c with different modulation frequencies fa, fb and fc, respectively (for example by way of suitable drivers). The modulation frequencies fa, fb and fc are relatively prime, in particular, with the result that an occurrence of an intermodulation can be prevented particularly effectively. The luminaires a, b, and c may each include at least one light emitting diode (not illustrated), in particular at least one light emitting diode which emits white light La to Lc. The luminaires a, b and c can have an identical construction.

FIG. 2 shows a succession or sequence of n individual images EB_r, EB_r+1, EB_-r+2, EB_r+n that were recorded by the camera K of the monitoring system S. Each of the individual images EB has a plurality of pixels BP(x,y), e.g. with x and/or y from a set {1024×640}.

On account of the modulation of the luminaires a to c, the illumination situations of the pixels BP(x,y) are different at the time of the recordings of the individual images EB_r to EB_r+n.

FIG. 3 shows a time series of measurement values of a specific pixel BP(x,y) from the sequence of the individual images EB_r to EB_r+n. The magnitude or the value of the pixel BP(x,y) at a respective point in time is a (“pixel”) measurement value PMw(x,y) and can correspond e.g. to a brightness value.

FIG. 4 shows Fourier components FT_a, FT_b, FT_c as a result of a standard Fourier analysis of the time series of measurement values PMw(tr), . . . , PMw(tr+n) at points in time tr, . . . , tr+n from FIG. 3. The standard Fourier analysis can be a fast Fourier transformation (FFT), for example.

The magnitudes or values of the Fourier components FT_a, FT_b and FT_c correspond to representative intensity measurement values Iw which include only the portions of the light components La, Lb and Lc of the luminaires a, b and c, respectively.

FIG. 5 shows three partial images TBa, TBb and TBc obtained from the Fourier analysis. The partial images TBa, TBb and Tc respectively include or include the intensity measurement values Iw of the associated Fourier components FTa, FTb and FTc at the respective pixels BP(x,y).

The three partial images TBa, TBb and TBc correspond to individual images that would have been recorded only upon illumination by a respective one of the luminaires a, b and c. As indicated by the arrow, these three partial images TBa, TBb and TBc can be used as input images for a photometric stereo analysis in order to reconstruct the object surfaces OS1, OS2.

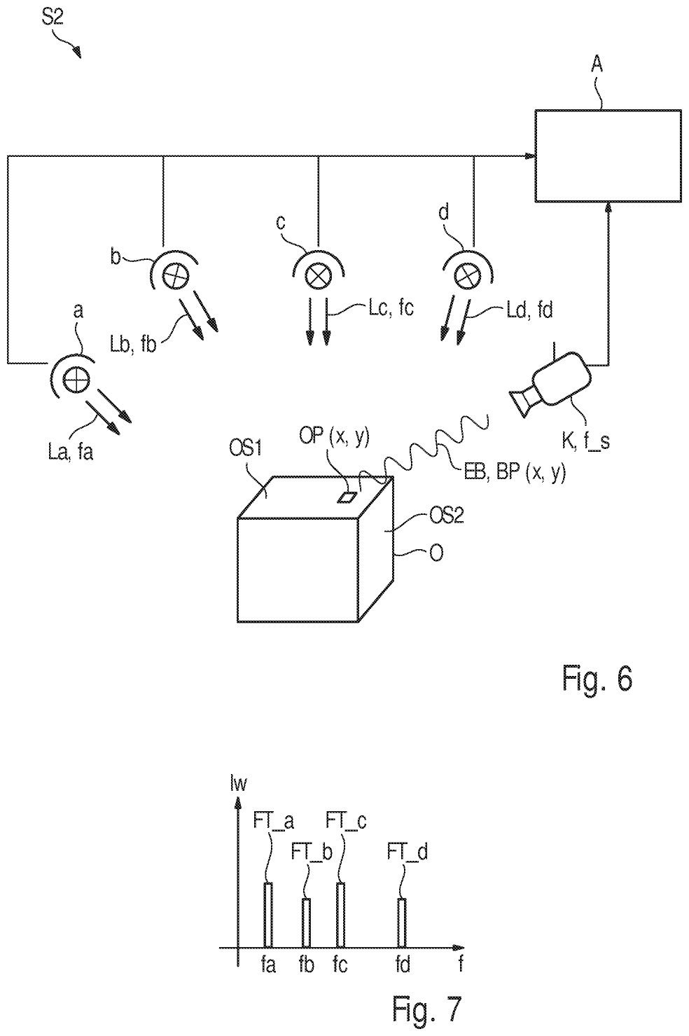

FIG. 6 shows a monitoring system S2 in accordance with a second exemplary embodiment. The monitoring system S2 is constructed similarly to the monitoring system S1, but now includes a further luminaire d, which emits modulated light Ld having a modulation frequency fd.

FIG. 7 shows, analogously to FIG. 4, a result of a standard Fourier analysis of the time series of measurement values of a pixel BP(x,y) of a sequence of individual images EB_r, Eb_r+n that were recorded by the camera K of the monitoring system S2. Four Fourier components FT_a to FT_d corresponding to the modulation frequencies fa to fd now result.

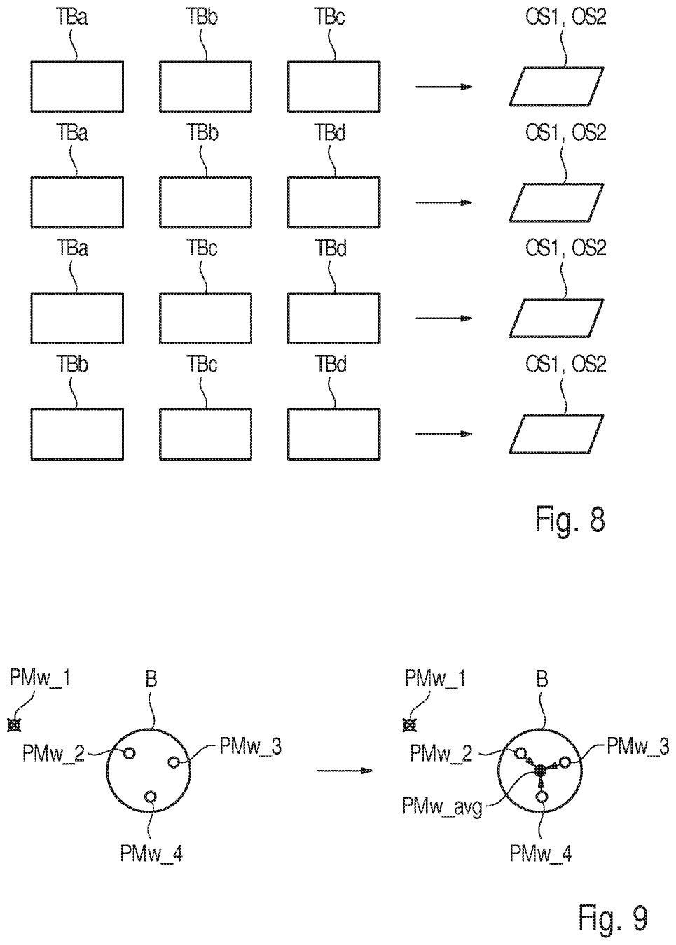

From the four Fourier components FT_a to FT_d of all the pixels, it is possible to generate four corresponding partial images TBa to TBd (see FIG. 8).

FIG. 8 shows the corresponding partial images TBa to TBd generated from four usable different triplet groups of luminaire combinations by means of Fourier transformations. They are the partial images TBa, TBb and Tc of the luminaire combination {a, b, c},the partial images TBa, TBb and TBd of the luminaire combination {a, b, d}, the partial images TBa, TBc and TBd of the luminaire combination {a, c, d} and the partial images TBb, TBc and TBd of the luminaire combination {b, c, d}. From the respective triplets of the partial images.

However, since only three partial images are required for a photometric stereo analysis, in each case an independent photometric surface reconstruction of the object surfaces OS1, OS2 of the object O can be carried out from the triplets of the partial images TBa to TBd.

The four independent surface reconstructions can be used by means of superimposition to form a consistent end result for the surface reconstruction. This takes account of the fact that deviations of the surfaces OS1, OS2 reconstructed by means of the different triplets can occur in practice, e.g. on account of shadings or luster effects (specular albedo).

FIG. 9 shows a determination of a final pixel value PMw_final for a specific surface point OP(x,y) from a set of a plurality (here: four) of pixel values PMw_1 to PMw_4 for this same surface point OP(x,y). The four pixel values PMw_1 to PMw_4 thus correspond in each case to nominally the same surface point OP(x,y) resulting from the surfaces reconstructed by means of the four different luminaire combinations.

If one pixel value PMw_1 lies outside a predefined bandwidth B, which is indicated here by the circle, with respect to the other pixel values PMw_2 to PMw_4, it can be regarded as an outlier and be excluded from a consideration for determining the final pixel value PMw_final, as illustrated in the left-hand part of FIG. 9.

In principle, the exclusion method can also be applied to more than one of the surface points OP(x,y).

If all pixel values apart from one pixel value have been excluded, the pixel value that has remained is set as the final pixel value PMw_final.

If a plurality of pixel values PMw_2 to PMw_4 have remained, they can be averaged, for example, in order to calculate an averaged pixel value PMw_avg, which is used as the final surface point PMw_final. This is shown in the right-hand part of FIG. 9.

The consistency concepts above can be applied to all surface points OP(x,y) or reconstructed surfaces OS1, OS2.

Although the invention has been more specifically illustrated and described in detail by means of the exemplary embodiments shown, nevertheless the invention is not restricted thereto and other variations can be derived therefrom by the person skilled in the art, without departing from the scope of protection of the invention.

In this regard, the frame rate of the camera K can also be so low that undersampling is present.

Generally, “a(n)”, “one”, etc., can be understood to mean a singular or a plural, in particular in the sense of “at least one” or “one or a plurality”, etc., as long as this is not explicitly excluded, e.g. by the expression “exactly one”, etc.

Moreover, a numerical indication can encompass exactly the indicated number and also a customary tolerance range, as long as this is not explicitly excluded.

### LIST OF REFERENCE SIGNS

Evaluation device A
Luminaire a
Bandwidth
Pixel at the position (x,y) BP(x,y)
Luminaire
Luminaire
Luminaire
Individual images r, r+n EB_r to EB_r+n
Fourier component FT_a to FT_d
Modulation frequencies of the luminaires a to d
fa to Fd
Intensity measurement value Iw
Digital camera
Modulated light of the luminaires a to d La to Ld
Object O
Surface point of the pixel BP(x,y) OP(x,y)
Measurement value of the pixel BP(x,y) PMw(x,y)
Averaged pixel value PMw_avg
Final pixel value PMw_final
Pixel values of different triplets PWm_1 to PWm_4
Object surface OS1
Object surface OS2
Sampling rate f_s
Monitoring system S1 to S2
Partial image TBa to TBd

1. A method for surface reconstruction, wherein the method comprises:
illuminating at least one object simultaneously by light emitted by a plurality of luminaires spaced apart from one another;
recording a photographic sequence comprising a plurality of individual images of the at least one object; and
reconstructing at least one visible object surface of the object by photometric stereo analysis;
wherein:
the light emitted by the plurality of luminaires is modulated with different modulation frequencies;
the light components of the respective luminaires that are reflected by the object are identified on the basis of their modulation frequencies (fa-fc; fa-fd) and are assigned to respective partial images; and
the partial images are used configured as input images for the photometric stereo analysis.

2. The method as claimed in claim 1, wherein:
each pixel of the individual images of the sequence is subjected to a respective Fourier analysis, and
Fourier components obtained from the Fourier analysis, as values of the corresponding pixels, are assigned to the respective partial images.

3. The method as claimed in claim 1, wherein more than three luminaires of the plurality of luminaires with respective modulation frequencies are used.

4. The method as claimed in claim 3, wherein
the object is illuminated simultaneously by the more than three differently modulated luminaires,
respective partial images associated with the more than three luminaires are generated,
photometric stereo analyses are carried out for different luminaire combinations with three partial images in each case, and
the at least one visible object surface comprises at least two of the respectively resulting object surfaces combined to form a single final object surface.

5. The method as claimed in claim 2, wherein:
the modulation frequencies of the plurality of luminaires remain constant over time,
the plurality of individual images are recorded with a sampling rate of the camera that is higher than the modulation frequencies, and
the Fourier analysis is carried out for a frequency range extending maximally to half the sampling rate.

6. The method as claimed in claim 2, wherein:
the modulation frequencies of the plurality of luminaires remain constant over time,
the plurality of individual images are recorded with a sampling rate that is lower than the modulation frequencies, and
the Fourier analysis is carried out for a frequency range extending maximally to half the sampling rate.

7. The method as claimed in claim 2, wherein:
the modulation frequencies of the plurality of luminaires remain constant over time,
the plurality of individual images are recorded with a sampling rate that is lower than the modulation frequencies, and
before the Fourier analysis, a digital low-pass filter having a cut-off frequency corresponding to a sampling rate of the camera is applied to a temporal series of respective pixels.

8. The method as claimed in claim 2, wherein:
the modulation frequencies of the plurality of luminaires remains constant over time,
the individual images are recorded with a sampling rate that is lower than the modulation frequencies,
the Fourier analysis is carried out for a frequency range extending to the respective modulation frequency,
Fourier components of this frequency range of different sequences are averaged, and
the sampling rate and the modulation frequencies are not synchronized.

9. The method as claimed in claim 1, wherein at least one modulation amplitude remains constant.

10. An apparatus configured to carry out the method as claimed in claim 1.

11. The apparatus as claimed in claim 10, wherein each luminaire of the plurality of luminaires comprises at least one light emitting diode.

12. The apparatus as claimed in claim 10, wherein the apparatus is a monitoring system.
